(19) United States
(12) Patent Application Publication
(10) Pub. No.: US 2025/0297432 A1
(43) Pub. Date: Sep. 25, 2025

(54) UNIFORM SPREADING CONTROL SYSTEM

(71) Applicant: Dartpoint Tech. Co., Ltd., Taipei City (TW)

(72) Inventor: Chung-Hsin HSIEH, Taipei City (TW)

(21) Appl. No.: 19/085,316

(22) Filed: Mar. 20, 2025

Related U.S. Application Data
(60) Provisional application No. 63/568,556, filed on Mar. 22, 2024.

(51) Int. Cl. E01C 19/20; A01C 17/00

(52) U.S. Cl. CPC E01C 19/203; A01C 17/008; E01C 2019/2065

(57) ABSTRACT

A uniform spreading control system includes a control module, which includes a basic controller and a uniform spreading controller, and connected to a vehicle speed detector, a material transferring device, and a material spreading device. The uniform spreading controller is configured to obtain a vehicle speed from the vehicle speed detector, and control a material transferring speed of the material transferring device and/or a material spreading speed of the material spreading device. The uniform spreading controller is configured to enable an ultra-low speed pulsation mode when the vehicle speed is lower than a vehicle speed lower limit.

### CROSS REFERENCE TO RELATED APPLICATION

This application claims the benefit of filing date of U.S. Provisional Application Ser. No. 63/568,556, entitled “UNIFORM SPREADING CONTROL METHOD” filed Mar. 22, 2024 under 35 USC § 119(e)1.

### BACKGROUND OF THE INVENTION

### 1. Field of the Invention

The present invention relates to a uniform spreading control system and method, applicable to a vehicle, and let the vehicle to spread a material uniformly on the ground or any specific place.

### 2. Description of Related Art

There may be a demand to spread (or generally, distribute) a certain material on the ground, for example, to spread seeds on a farmland, to spread concrete on a construction site, to spread asphalt on a road, to spread salt on a snowfield, but not limited thereto. In general, the material may be in form of powder, granule, liquid, colloid, semi-solid, and so on, but not limited thereto. It is desired that the spreading can be performed in a uniform way so that the material can be uniformly presented on the ground.

The spreading is typically performed by a vehicle equipped with a material spreader, wherein the vehicle may be a truck, a tractor, a trailer, a train, a car, and so on, but not limited thereto. The spreading uniformity typically depends on the vehicle speed. For example, when the vehicle goes faster, the spreading shall be performed faster accordingly, so as to sufficiently fill up the space on the ground. On the contrary, when the vehicle goes slower, the spreading shall be performed slower accordingly, so as to avoid material accumulation. Accordingly, it is typical to set the spreading speed of the material spreader to be proportional to the vehicle speed.

To implement such proportional relationship between the spreading speed and the vehicle speed, a signal may be generated based on the vehicle speed and is then send to the material spreader to control the spreading speed.

However, if the vehicle speed becomes an ultra-low vehicle speed, the signal generated based on the ultra-low vehicle speed may be too weak to trigger (or drive) the material spreader. Therefore, one technical problem concerned and to be solved by the present invention is to achieve uniform spreading under an ultra-low vehicle speed.

Another technical problem may occur during the spreading is that the vehicle drives in different speeds or frequently stops and goes, which results in non-uniform spreading, and in turn causes the material to non-uniformly accumulate on the ground. This problem is also concerned and to be solve by the present invention.

Therefore, it is desirable to provide a novel and inventive uniform spreading control system and method to mitigate and/or obviate the aforementioned problems.

### SUMMARY OF THE INVENTION

In order to achieve uniform spreading under an ultra-low vehicle speed, the present invention provides a uniform spreading control system and a related method based on an “ultra-low speed pulsation mode” (also called a “burst control mode”), capable of dealing with material spreading under an ultra-low vehicle speed which the prior art cannot deal with, being released from the constraint in the prior art.

In particular, as previously mentioned, if the vehicle speed becomes an ultra-low vehicle speed, the signal generated based on the vehicle speed may be too weak to trigger the material spreading device. However, the present invention can generate a special signal based on the ultra-low vehicle speed, which can still trigger the material spreading device, and thus the present invention allows to spread a tinier amount of material than the prior art does.

According to a first aspect, the present invention provides a uniform spreading control system, including a control module, which includes a basic controller and a uniform spreading controller, and connected to a vehicle speed detector, a material transferring device, and a material spreading device. The uniform spreading controller is configured to obtain a vehicle speed from the vehicle speed detector, and control a material transferring speed of the material transferring device and/or a material spreading speed of the material spreading device. The uniform spreading controller is configured to enable an ultra-low speed pulsation mode when the vehicle speed is lower than a vehicle speed lower limit.

Optionally, or preferably, the vehicle speed detector includes an acceleration detector (G-sensor), a mechanical tachometer, and/or an on-board diagnostic (OBD).

Optionally, or preferably, the control module is further connected to a control panel adapted to be operated by a user.

Optionally, or preferably, the uniform spreading controller is configured to receive externally or store internally one or more dose supply reference values, perform an average algorithm according to the one or more dose supply reference values, and control the material transferring speed of the material transferring device and/or the material spreading speed of the material spreading device according to a result from the average algorithm.

Optionally, or preferably, the material transferring device is a belt conveyor, a screw conveyor, or a feeder. The material spreading device is a material throwing rotating disc, a material throwing round disc, a spreading rotating disc, or a spreader.

Optionally, or preferably, the material transferring device includes a first motor and a first power supply, and the uniform spreading controller is configured to control a first power of the first power supply, so as to control a first rotational speed of the first motor, thereby controlling the material transferring speed of the material transferring device. Similarly, the material spreading device includes a second motor and a second power supply or variable-frequency drive, and the uniform spreading controller is configured to control a second power of the second power supply or variable-frequency drive, so as to control a second rotational speed of the second motor, thereby controlling the material spreading speed of the material spreading device.

Optionally, or preferably, the material transferring speed of the material transferring device and/or the material spreading speed of the material spreading device is fed back to the uniform spreading controller.

Optionally, or preferably, in the ultra-low speed pulsation mode, the uniform spreading controller is configured to control the material transferring speed of the material transferring device and/or the material spreading speed of the material spreading device by wave-enveloped pulse train.

Optionally, or preferably, the uniform spreading controller includes a wave-enveloped pulse train generation circuit, the wave-enveloped pulse train generation circuit includes a pulse-width modulation (PWM) timer and a burst timer, the PWM timer is configured to receive pulse train, the burst timer is configured to receive an envelope signal, and the wave-enveloped pulse train generation circuit is configured to perform logic AND operation on the pulse train and the envelope signal, and output the wave-enveloped pulse train.

Optionally, or preferably, the logic AND operation is implemented by a gating control pin that connects the burst timer to the PWM timer, or implemented by a logic AND gate that is connected to the PWM timer and the burst timer.

Optionally, or preferably, the vehicle speed lower limit corresponds to an original material transferring speed lower limit of the material transferring device and/or an original material spreading speed lower limit of the material spreading device.

Optionally, or preferably, the wave-enveloped pulse train is defined with a complete period (T), and the complete period (T) includes a pulse train existing period (Te) and a pulse train non-existing period (Ti). A ratio (Te/T) of the pulse train existing period (Te) to the complete period (T) determines a further reduced material transferring speed lower limit (VL30f), equal to the original material transferring speed lower limit times the ratio [VL30i×(Te/T)] and/or a further reduced material spreading speed lower limit (VL40f), equal to the original material spreading speed lower limit times the ratio [VL40i×(Te/T)].

Optionally, or preferably, the vehicle speed lower limit is 10 miles per hour, 8 miles per hour, 6 miles per hour, 4 miles per hour, or 2 miles per hour.

Optionally, or preferably, the ultra-low speed pulsation mode includes a plurality of sub ultra-low speed pulsation modes, and the sub ultra-low speed pulsation modes include a first sub ultra-low speed pulsation mode and a second sub ultra-low speed pulsation mode. In the first sub ultra-low speed pulsation mode, the vehicle speed is between the vehicle speed lower limit and a first vehicle speed lower limit, and the uniform spreading controller is configured to control the material transferring speed of the material transferring device and/or the material spreading speed of the material spreading device by first wave-enveloped pulse train. In the second sub ultra-low speed pulsation mode, the vehicle speed is between the first vehicle speed lower limit and a second vehicle speed lower limit, and the uniform spreading controller is configured to control the material transferring speed of the material transferring device and/or the material spreading speed of the material spreading device by second wave-enveloped pulse train. Herein, it can be understood that, more sub ultra-low speed pulsation modes may be implemented by extending the concept from the first sub ultra-low speed pulsation mode and the second sub ultra-low speed pulsation mode.

On the other hand, in order to achieve uniform spreading under a situation where the vehicle frequently stops and goes, which has highly possibility to cause non-uniform material accumulation, the present invention also provides a solution, that is, to set a time difference between the operating time of the material spreading device and the operating time of the material transferring device at the moment the vehicle starts or stops, so as to avoid material accumulation on the material spreading device itself and spreading non-uniformity on the ground.

According to a second aspect, the present invention provides a uniform spreading control system, including a control module, which includes a basic controller and a uniform spreading controller, and connected to a vehicle speed detector, a material transferring device, and a material spreading device. The uniform spreading controller is configured to obtain a vehicle speed from the vehicle speed detector, and control a material transferring speed of the material transferring device and/or a material spreading speed of the material spreading device. A first start time of the material transferring device is later than a second start time of the material spreading device.

Optionally, or preferably, a first stop time of the material transferring device is earlier than a second stop time of the material spreading device.

Optionally, or preferably, there exists a first time difference between the first start time of the material transferring device and the second start time of the material spreading device. Similarly, there exists a second time difference between the first stop time of the material transferring device and the second stop time of the material spreading device.

Optionally, or preferably, the first time difference and/or the second time difference is a fixed value, equal to 0.5 seconds, 1 second, 1.5 seconds, or a variable value, varying between 0.5 seconds and 1.5 seconds.

Optionally, or preferably, the uniform spreading controller is configured to, when the vehicle speed is higher than a start basic vehicle speed, start the material spreading device first, and then after the first time difference elapses, start the material transferring device. Similarly, the uniform spreading controller is configured to, when the vehicle speed is lower than a stop basic vehicle speed, stop the material transferring device first, and then after the second time difference elapses, stop the material spreading device.

Optionally, or preferably, the control module is connected to a material spreading device detector, and the control module is configured to, before the material spreading device is activated, if the material spreading device detector detects that the material spreading device remains any residual material, then activate the material spreading device to remove or spread the residual material.

It can be understood that, the first aspect and the second aspect may be combined with each other. The optional or preferably features in the first aspect may be applied to the second aspect if suitable and with necessary modification. Similarly, the optional or preferably features in the second aspect may be applied to the first aspect if suitable and with necessary modification.

Other aspects, novel features, and advantages of the present invention will become more apparent from the following detailed description when taken in conjunction with the accompanying drawings.

### BRIEF DESCRIPTION OF THE DRAWINGS

FIG. 1 is a block diagram of the uniform spreading control system according to one embodiment of the present invention;

FIG. 2 is a schematic diagram of traditional pulse train to control a motor in the prior art;

FIG. 3 is a schematic diagram of three kinds of wave-enveloped pulse trains to control the material transferring device and/or the material spreading device according to one embodiment of the present invention;

FIGS. 4A and 4B are schematic diagrams of two kinds of wave-enveloped pulse train generation circuit according to two embodiments of the present invention;

FIG. 5 is a flowchart illustrating the uniform spreading control method according to one embodiment of the present invention;

FIG. 6 shows a block diagram of the uniform spreading control system according to another embodiment of the present invention on the top portion of the figure, a timeline illustrating the operation timing for the uniform spreading control system on the middle portion of the figure, and a schematic diagram of three kinds of wave-enveloped pulse trains on the bottom portion of the figure; and

FIG. 7 is a flowchart illustrating the uniform spreading control method according to another embodiment of the present invention.

### DETAILED DESCRIPTION OF THE EMBODIMENT

Different embodiments of the present invention are provided in the following description. These embodiments are meant to explain the technical content of the present invention, but not meant to limit the scope of the present invention. A feature described in an embodiment may be applied to other embodiments by suitable modification, substitution, combination, or separation.

It should be noted that, in the present specification, when a component is described to have an element, it means that the component may have one or more such elements, and it does not mean that the component has only one such element, except otherwise specified.

Moreover, in the present specification, the ordinal numbers, such as “first” or “second”, are used to distinguish a plurality of elements having the same name, and it does not mean that there is essentially a level, a rank, an executing order, or a manufacturing order among the elements, except otherwise specified. A “first” element and a “second” element may exist together in the same component, or alternatively, they may exist in different components, respectively. The existence of an element described) by a greater ordinal number does not essentially mean the existent of another element described by a smaller ordinal number.

Moreover, in the present specification, when an element is described to be arranged “on” another element, it does not essentially mean that the elements contact the other element, except otherwise specified. Such interpretation is applied to other cases similar to the case of “on”.

Moreover, in the present specification, the terms, such as “preferably” or “advantageously”, are used to describe an optional or additional element or feature, and in other words, the element or the feature is not an essential element, and may be ignored in some embodiments.

Moreover, in the present specification, when an element is described to be “suitable for” or “adapted to” another element, the other element is an example or a reference helpful in imagination of properties or applications of the element, and the other element is not to be considered to form a part of a claimed subject matter; similarly, except otherwise specified; similarly, in the present specification, when an element is described to be “suitable for” or “adapted to” a configuration or an action, the description is made to focus on properties or applications of the element, and it does not essentially mean that the configuration has been set or the action has been performed, except otherwise specified.

Moreover, each component may be realized as a single circuit or an integrated circuit in suitable ways, and may include one or more active elements, such as transistors or logic gates, or one or more passive elements, such as resistors, capacitors, or inductors, but not limited thereto. Each component may be connected to each other in suitable ways, for example, by using one or more traces to form series connection or parallel connection, especially to satisfy the requirements of input terminal and output terminal. Furthermore, each component may allow transmitting or receiving input signals or output signals in sequence or in parallel. The aforementioned configurations may be realized depending on practical applications.

Moreover, in the present specification, the terms, such as “system”, “apparatus”, “device”, “module”, or “unit”, refer to an electronic element, or a digital circuit, an analogous circuit, or other general circuit, composed of a plurality of electronic elements, and there is not essentially a level or a rank among the aforementioned terms, except otherwise specified.

Moreover, in the present specification, two elements may be electrically connected to each other directly or indirectly, except otherwise specified. In an indirect connection, one or more elements, such as resistors, capacitors, or inductors may exist between the two elements. The electrical connection is used to send one or more signals, such as DC or AC currents or voltages, depending on practical applications.

Moreover, in the present specification, a value may be interpreted to cover a range within ±10% of the value, and in particular, a range within ±5% of the value, except otherwise specified; a range may be interpreted to be composed of a plurality of subranges defined by a smaller endpoint, a smaller quartile, a median, a greater quartile, and a greater endpoint, except otherwise specified.

### The Uniform Spreading Control System and Method in the Ultra-Low Speed Pulsation Mode

The so-called “ultra-low speed pulsation (ULSP) mode” of the present invention is also called “burst control mode”, and both of the two terms may be used in the present specification to refer a specific mode to be enabled when a vehicle speed V is lower than a vehicle speed lower limit VL.

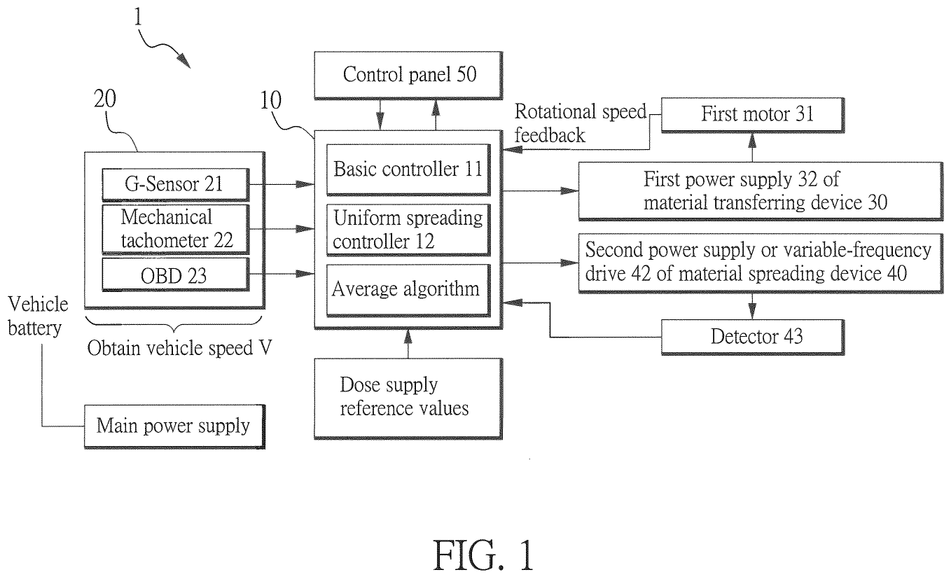

FIG. 1 is a block diagram of the uniform spreading control system 1 according to one embodiment of the present invention.

The uniform spreading control system 1 can be equipped in or attached to a vehicle (not shown), which may be a truck, a tractor, a trailer, a train, a car, and so on, but not limited thereto. A material tank (not shown), a material transferring device 30, and a material spreading device 40 are arranged on the vehicle, they may be either integrated or separate parts of the vehicle. A material to be spread will be transferred from the material tank via the material transferring device 30 to the material spreading device 40. The material to be spread may be in form of powder, granule, liquid, colloid, semi-solid, and so on, but not limited thereto.

As shown in FIG. 1, the uniform spreading control system 1 includes a control module 10. The control module 10 includes a basic controller 11 and a uniform spreading controller 12. The control module 10 or the uniform spreading controller 12 can perform an average algorithm. The basic controller 11, the uniform spreading controller 12, and the average algorithm are illustrated as three separate blocks only for convenience of comprehension, but they may be implemented in any suitable form. For example, the uniform spreading controller 12 may be incorporated into the basic controller 11, and configured to access the average algorithm saved in the control module 10. Alternatively, the average algorithm may be saved in and accessed by the uniform spreading controller 12, separated from the basic controller 11. Further alternatively, the basic controller 11, the uniform spreading controller 12, and the average algorithm may be combined into a single component.

The controller module 10 may be implemented as a microprocessor (μP), a microcontroller unit (MCU), an application specific processor (ASP), and so on, but not limited thereto. The basic controller 11 may provide basic functions, such as by a processor unit, a power supply unit, a memory unit, an input and output interface, a communications interface, and so on, but not limited thereto, and their details are omitted here.

The control module 10 is connected to a vehicle speed detector 20, the material transferring device 30, and the material spreading device 40. It should be understood that, the main part of the uniform spreading control system 1 is the control module 10, while, the material transferring device 30 and the material spreading device 40 may or may not be deemed as parts of the uniform spreading control system 1 since they are merely parts on the vehicle and to be controlled.

The vehicle speed detector 20 may include an acceleration detector (G-sensor) 21, a mechanical tachometer 22, and/or an on-board diagnostic (OBD) 23. These components are used to obtain the vehicle speed V, and their types and mechanisms are well-known, so their details are omitted here. The vehicle speed V is used for the uniform spreading controller 12 of the control module 10 to determine whether to enable the ultra-low speed pulsation mode of the present invention.

The material transferring device 30 may be a belt conveyor, a screw conveyor, or a feeder, but not limited thereto, as long as it can transfer the material to be spread from the material tank to the material spreading device 40. In particular, the material transferring device 30 includes a first motor 31 and a first power supply 32. The uniform spreading controller 12 is configured to control a first power of the first power supply 32, so as to control a first rotational speed of the first motor 31, thereby controlling a material transferring speed V30 of the material transferring device 30. The communication interface between the control module 10 (or its uniform spreading controller 12) and the material transferring device 30 (or its first motor 31) may be a CAN Bus, an RS485, or other serial interfaces. The material transferring speed V30 may be defined in any suitable way, for linear motion or rotational motion, and may further correspond to any of the weight of the transferred material per unit time, the volume of the transferred material per unit time, the coverage area of the transferred material per unit time, and so on, but not limited thereto, as long as it can suitably be associated with the spreading uniformity.

The material spreading device 40 may be a material throwing rotating disc, a material throwing round disc, a spreading rotating disc, or a spreader, but not limited thereto, as long as it can spread the material to the ground or any specific place. The material spreading device 40 includes a second motor 41 and a second power supply or variable-frequency drive 42. The uniform spreading controller 12 is configured to control a second power of the second power supply or variable-frequency drive 42, so as to control a second rotational speed of the second motor 41, thereby controlling a material spreading speed V40 of the material spreading device 40. The communication interface between the control module 10 (or its uniform spreading controller 12) and the material spreading device 40 (or its second motor 41) may be a CAN Bus, an RS485, or other serial interfaces. The material spreading speed V40 may be defined in any suitable way, for linear motion or rotational motion, and may further correspond to any of the weight of the spread material per unit time, the volume of the spread material per unit time, the coverage area of the spread material per unit time, and so on, but not limited thereto, as long as it can suitably be associated with the spreading uniformity.

In one embodiment, the material transferring speed V30 of the material transferring device 30 and/or the material spreading speed V40 of the material spreading device 40 may be fed back to the uniform spreading controller 12, so that the uniform spreading controller 12 can confirm these speeds as well as confirm whether its control is effective.

In some cases, the control module 10 may further be connected to a control panel 50 adapted to be operated by a user. The control panel 50 may be an independent control panel dedicated to the uniform spreading control system 1 of the present invention, or it may be integrated as a part of a dashboard of the vehicle, but not limited thereto. In other cases, the control module 10 may be operated wirelessly by a mobile application (APP) of a mobile device, but not limited thereto.

As shown in the bottom-left portion of FIG. 1, there is a main power supply used to supply electrical power to the uniform spreading control system 1, in particular to its internal components. The main power supply may be connected to a vehicle battery, for example.

To discuss in detail the uniform spreading mechanism in the ultra-low speed pulsation mode of the present invention, as previously mentioned, the uniform spreading controller 12 of the control module 10 is configured to obtain the vehicle speed V from the vehicle speed detector 20, and accordingly control the material transferring speed V30 of the material transferring device 30 and/or the material spreading speed V40 of the material spreading device 40. It can be understood that, since both of the material transferring speed V30 of the material transferring device 30 and the material spreading speed V40 of the material spreading device 40 may affect the spreading, controlling either of them can avoid material accumulation.

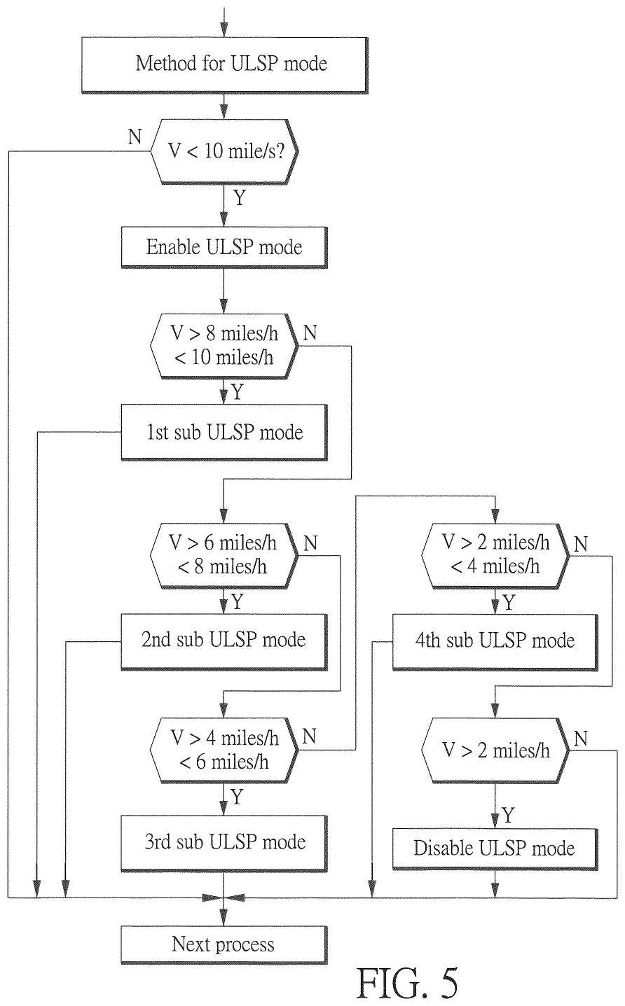

The uniform spreading controller 12 is configured to enable the ultra-low speed pulsation mode when the vehicle speed V is lower than the vehicle speed lower limit VL. As can be seen in FIG. 5, for example, the vehicle speed lower limit VL may be 10 miles per hour, 8 miles per hour, 6 miles per hour, 4 miles per hour, or 2 miles per hour, but not limited thereto, and it is not necessary to be an integer.

The uniform spreading controller 12 is configured to receive externally or store internally one or more dose supply reference values. Receiving externally means accessing the one or more dose supply reference values via a wire or wirelessly from an external memory. Storing internally means accessing the one or more dose supply reference values from an internal memory of the control module 10. The one or more dose supply reference values may be presented as a reference table or any other suitable form. The reference table can tell, corresponding to the vehicle speed V, how many doses of the material shall be used in the spreading, in particular, the amount of the material to be transferred by the material transferring device 30 from the material tank to the material spreading device 40, and finally be spread to the ground. The one or more dose supply reference values may be generated initially based on experience for a normal vehicle speed, and may be updated by interpolation, extrapolation, or other mathematic methods, and may also be updated by an artificial intelligence. The normal vehicle speed means the vehicle speed higher than the vehicle speed lower limit VL in which the material transferring device 30 and the material spreading device 40 can be triggered normally. However, when the vehicle speed V is lower than the vehicle speed lower limit VL, the technical problem concerned by the present invention will occur, and the uniform spreading control system 1 shall enter the ultra-low speed pulsation mode of the present invention. In the ultra-low speed pulsation mode, the uniform spreading controller 12 performs an average algorithm according to the one or more dose supply reference values, and control the material transferring speed V30 of the material transferring device 30 and/or the material spreading speed V40 of the material spreading device 40 according to a result from the average algorithm.

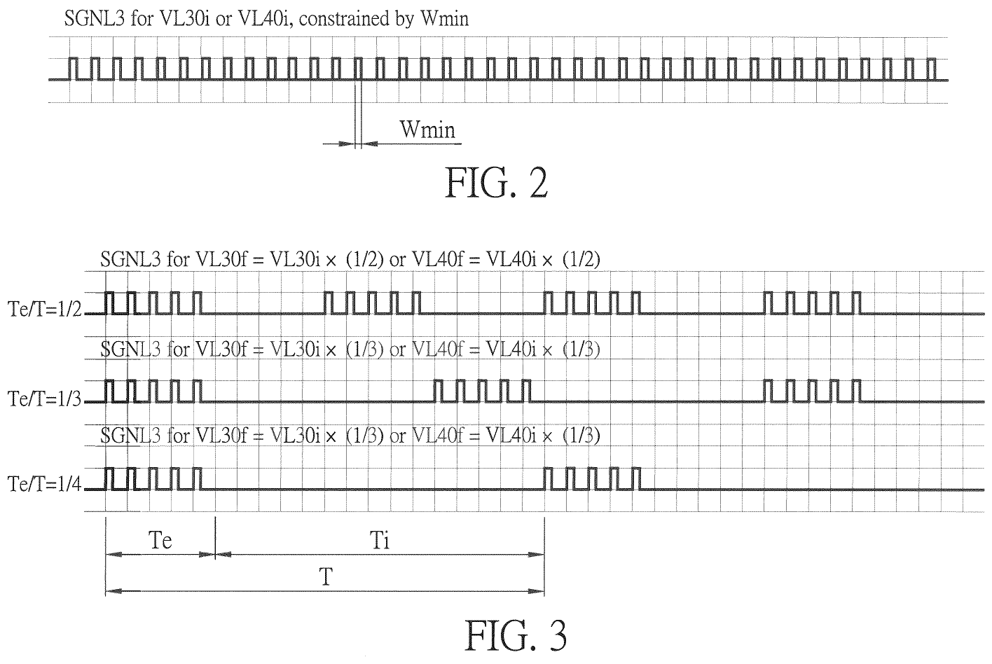

FIG. 2 is a schematic diagram of traditional pulse train to control a motor in the prior art.

“Pulse train”, also called “pulse wave” or “rectangular wave”, is a non-sinusoidal waveform that is a periodically presenting rectangular function. The pulse train is used as a basis for other waveforms that modulate an aspect of the pulse train. For example, pulse-width modulation (PWM) is used to modulate the pulse train by varying the duty cycle of the pulse train. Pulse-amplitude modulation (PAM) is used to modulate the pulse train by varying the amplitude of the pulse train.

The motor herein may be the first motor 31 of the material transferring device 30 or the second motor 41 of the material spreading device 40 of the present invention, and it shall not be confused with the motor of the vehicle itself. In case the traditional pulse train is used in the present invention, the traditional pulse train will be sent to the motor (or specifically, its power supply or variable-frequency drive), so as to control its rotational speed, thereby controlling the material transferring speed V30 and/or the material spreading speed V40. It can be understood that, the material transferring speed V30 and/or the material spreading speed V40 shall basically be positively correlated (specifically, proportional) to the vehicle speed V to remain the spreading uniformity, which means that, if the vehicle goes fast, it needs a faster material transferring speed V30and/or a faster material spreading speed V40 to sufficiently fill up the space on the ground, and the faster material transferring speed V30 and/or the faster material spreading speed V40 may be implemented by using the traditional pulse train with higher duty cycle; else if the vehicle goes slow, it needs a slower material transferring speed V30 and/or a slower material spreading speed V40 to avoid material accumulation, and the slower material transferring speed V30 and/or the slower material spreading speed V40 may be implemented by using the traditional pulse train with lower duty cycle.

However, as shown in FIG. 2, each pulse in the traditional pulse train has a minimum pulse width Wmin. A pulse with a pulse width smaller than the minimum pulse width Wmin will not have enough power to trigger the motor to rotate. In other words, in the prior art, the duty cycle of the traditional pulse train cannot be limitlessly lowered, so that there is a minimum duty cycle. Therefore, in the prior art, the traditional pulse train cannot be used to deal with the material spreading with an ultra-low vehicle speed V, and the constraint given by the minimum pulse width Wmin or the minimum duty cycle of the traditional pulse train defines the “vehicle speed lower limit VL” in the present specification. We can say that the vehicle speed lower limit VL corresponds to an original material transferring speed lower limit VL30i of the material transferring device 30 and/or an original material spreading speed lower limit VL40i of the material spreading device 40. It can therefore be understood that, how to create a kind of pulse train to deal with the case of ultra-low vehicle speed V and achieve the uniform spreading is the technical problem to be solved by the present invention.

FIG. 3 is a schematic diagram of three kinds of wave-enveloped pulse trains SGNL3 to control the material transferring device 30 and/or the material spreading device 40 according to one embodiment of the present invention.

According to the present invention, in the ultra-low speed pulsation mode, the uniform spreading controller 12 is configured to control the material transferring speed V30 of the material transferring device 30 and/or the material spreading speed V40 of the material spreading device 40 by wave-enveloped pulse train SGNL3. The wave-enveloped pulse train SGNL3 is created to further reduce the material transferring speed V30 of the material transferring device 30 and/or the material spreading speed V40 of the material spreading device 40, while under the constraint given by the minimum pulse width Wmin or the minimum duty cycle of the traditional pulse train.

Therefore, the present invention proposes to generate a signal to control the motor (that is, the wave-enveloped pulse train SGNL3), which is relatively sparse compared to the original signal (that is, the pulses of the pulse train SGNL1). To quantitively describe the property of the wave-enveloped pulse train SGNL3, the wave-enveloped pulse train SGNL2 may be defined with a complete period T, and the complete period T includes a pulse train existing period Te and a pulse train non-existing period Ti. Then, we can calculate a ratio (Te/T) of the pulse train existing period Te to the complete period T, which may be used to define the sparsity of the wave-enveloped pulse train SGNL3 compared to the pulses of the pulse train SGNL1. In FIG. 3, T, Te, and Ti, are marked on the wave-enveloped pulse train SGNL3 in the bottom portion of FIG. 3 only for convenience of illustration. A person skilled in the art can understood how to mark them on other wave-enveloped pulse trains SGNL3.

When the wave-enveloped pulse train SGNL3 is used to control the material transferring speed V30 of the material transferring device 30 and/or the material spreading speed V40 of the material spreading device 40, it can be expected that the material transferring device 30 and/or the material spreading device 40 will operate less frequently, and thus operate for less total time duration, thereby allowing to spread a tinier amount of material than in the prior art. In other words, we can say that the ratio (Te/T) of the pulse train existing period Te to the complete period T determines a further reduced material transferring speed lower limit VL30f, equal to the original material transferring speed lower limit VL30i×(Te/T) and/or a further reduced material spreading speed lower limit VL40f, equal to the original material spreading speed lower limit VL40i×(Te/T).

For example, the wave-enveloped pulse train SGNL3 in the top portion of FIG. 3 can trigger (or drive) the motor at a speed equal to ½ of the original speed lower limit (constrained by the minimum pulse width Wmin or the minimum duty cycle of the traditional pulse train), which can correspond to a first ultra-low vehicle speed in a first sub ultra-low speed pulsation mode, as will be discussed later; the wave-enveloped pulse train SGNL3 in the middle portion of FIG. 3 can trigger the motor at a speed equal to ⅓ of the original speed lower limit, which can correspond to a second ultra-low vehicle speed in a second sub ultra-low speed pulsation mode; the wave-enveloped pulse train SGNL3 in the bottom portion of FIG. 3 can trigger the motor at a speed equal to ¼ of the original speed lower limit, which can correspond to a third ultra-low vehicle speed in a third sub ultra-low speed pulsation mode; and so on. It should also be noted that, the correspondence between the vehicle speed V and the material transferring speed V30 or the material spreading speed V40 is not necessarily limited to a linear relationship but may be generally expanded to any kind of positive correlation relationship.

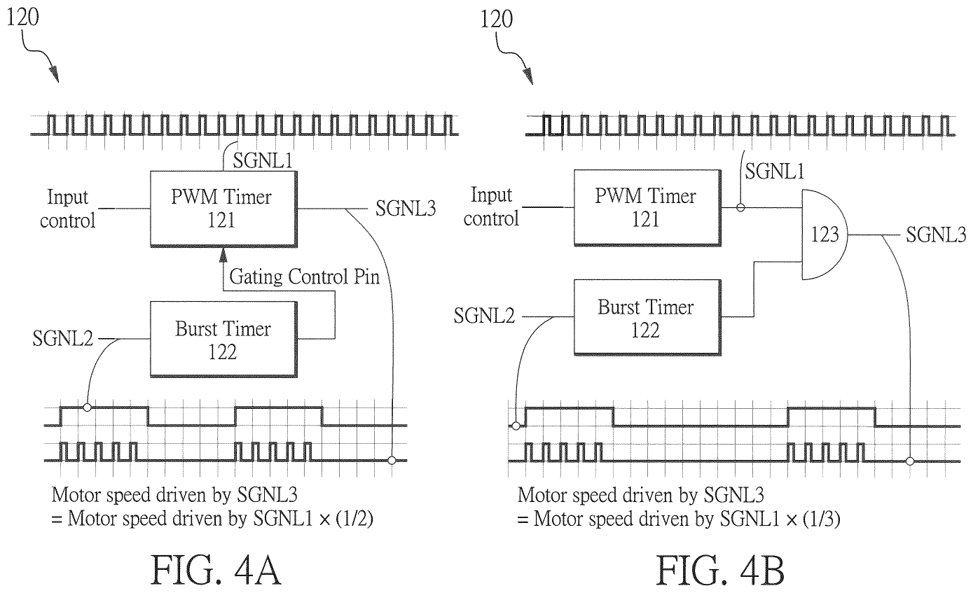

FIGS. 4A and 4B are schematic diagrams of two kinds of wave-enveloped pulse train generation circuit 120 according to two embodiments of the present invention.

In order to specifically implement the wave-enveloped pulse train SGNL3, as shown either in FIGS. 4A or 4B, the uniform spreading controller 12 may further include a wave-enveloped pulse train generation circuit 120. The wave-enveloped pulse train generation circuit 120 includes a pulse-width modulation (PWM) timer 121 and a burst timer 122. The PWM timer 121 is configured to receive pulse train SGNL1, and the pulse train SGNL1 is a periodic signal, which has periodic pulses with the minimum pulse width or the minimum duty cycle. The burst timer 122 is configured to receive an envelope signal SGNL2, the envelope signal SGNL2 may be a periodic signal or a non-periodic signal, and anyway each pulse of the envelope signal SGNL2 has a larger pulse width that can cover several pulses of the pulse train SGNL1. The wave-enveloped pulse train generation circuit 120 is configured to perform logic AND operation on the pulse train and the envelope signal, and output the wave-enveloped pulse train SGNL3. Accordingly, in the outputted wave-enveloped pulse train SGNL3, the pulses of the pulse train SGNL1 covered by the pulses of the envelope signal SGNL2 can survive (or remain to exist), while the pulses of the pulse train SGNL1 not covered by the pulses of the envelope signal SGNL2 will disappear.

According to one embodiment as shown in FIG. 4A, the logic AND operation may be implemented by a gating control pin that connects the burst timer 122 to the PWM timer 121. Since the PWM timer 121 only works when a high envelope signal SGNL2 comes in its gating control pin, and accordingly outputs the wave-enveloped pulse train SGNL3, it is equivalent to using a logic AND gate.

According to another embodiment as shown in FIG. 4B, the logic AND operation may be implemented by a logic AND gate 123 that is connected to the PWM timer 121 and the burst timer 122. Only when the output from the PWM timer 121 and the output from the burst timer 122 are both high does the logic AND gate 123 output the wave-enveloped pulse train SGNL3.

FIG. 5 is a flowchart illustrating the uniform spreading control method, in particular for the ultra-low speed pulsation (ULSP) mode, according to one embodiment of the present invention.

In general, the ultra-low speed pulsation mode of the present invention may include a plurality of sub ultra-low speed pulsation modes, and the sub ultra-low speed pulsation modes may include at least a first sub ultra-low speed pulsation mode and a second sub ultra-low speed pulsation mode. In the first sub ultra-low speed pulsation mode, the vehicle speed V is between the vehicle speed lower limit VL and a first vehicle speed lower limit VL1, and the uniform spreading controller 12 is configured to control the material transferring speed V30 of the material transferring device 30 and/or the material spreading speed V40 of the material spreading device 40 by first wave-enveloped pulse train. Similarly, in the second sub ultra-low speed pulsation mode, the vehicle speed V is between the first vehicle speed lower limit VL1 and a second vehicle speed lower limit VL2, and the uniform spreading controller 12 is configured to control the material transferring speed V30 of the material transferring device 30 and/or the material spreading speed V40 of the material spreading device 40 by second wave-enveloped pulse train. It can be understood that, more sub ultra-low speed pulsation modes may be implemented by extending the concept from the two sub ultra-low speed pulsation modes.

Now, referring to FIG. 5, the first step of the uniform spreading control method of the present invention is to determine whether to enable (or enter) the ultra-low speed pulsation mode. In this case, the vehicle speed lower limit VL is set to 10 miles per hour, for example, but not limited. It can be understood that, the vehicle speed lower limit VL is associated with the minimum pulse width Wmin or the minimum duty cycle of the traditional pulse train, as previously discussed. Accordingly, the first decision block asks whether the vehicle speed V is lower than the vehicle speed lower limit VL. If the answer is no (N), it goes to a next process, typically a normal spreading process; if the answer is yes (Y), it enables the ultra-low speed pulsation mode. As an option, the control panel 50 may display some information related to the ultra-low speed pulsation mode.

In this case, there are four sub ultra-low speed pulsation modes.

When the vehicle speed V is between 10 miles per hour and 8 miles per hour, it belongs to the first sub ultra-low speed pulsation mode; when the vehicle speed V is between 8 miles per hour and 6 miles per hour, it belongs to the second sub ultra-low speed pulsation mode; when the vehicle speed V is between 6 miles per hour and 4 miles per hour, it belongs to the third sub ultra-low speed pulsation mode; and when the vehicle speed V is between 6 miles per hour and 2 miles per hour, it belongs to the fourth sub ultra-low speed pulsation mode. After each sub ultra-low speed pulsation mode is executed, it goes to the next process, typically the normal spreading process. It is noted that, when the vehicle speed V is lower than an extremely low speed, in this case, 2 miles per hour, for example, the vehicle speed V is considered to be too slow and even the ultra-low speed pulsation mode of the present invention cannot help, typically because even the wave-enveloped pulse train generated in the ultra-low speed pulsation mode fails to have enough power to trigger the first motor 31 of the material transferring device 30 and/or the second motor 41 of the material spreading device 40.

The uniform spreading control method in FIG. 1 can be implemented by the uniform spreading control system 1, in particular by the circuit design or program design of the control module 10 or its uniform spreading controller 12. Each process step and each decision in FIG. 5 can be understood following the context of the present description, so the detail thereof is omitted here.

So far, the present specification has illustrated the uniform spreading control system and method in the ultra-low speed pulsation mode of the present invention, along with how it solves the technical problem faced by the prior art. The uniform spreading control system and method of the present invention can deal with material spreading under an ultra-low vehicle speed which the prior art cannot deal with, being released from the constraint in the prior art. In particular, even if the vehicle drives at the ultra-low vehicle speed, the first motor 31 of the material transferring device 30 and/or the second motor 41 of the material spreading device 40 can still be triggered by the signal generated based on the ultra-low vehicle speed, and thus it allows to spread a tinier amount of material than in the prior art.

### The Uniform Spreading Control System and Method in the Stop and Go Mode

The so-called “stop and go mode” of the present invention refers a specific mode to be enabled when a vehicle drives in different speeds or frequently stops and goes.

In the following description, the present invention proposes to set a time difference between the operating time of the material spreading device 40 and the operating time of the material transferring device 30 at the moment the vehicle starts or stops, so as to avoid material accumulation on the material spreading device 40 itself and spreading non-uniformity on the ground.

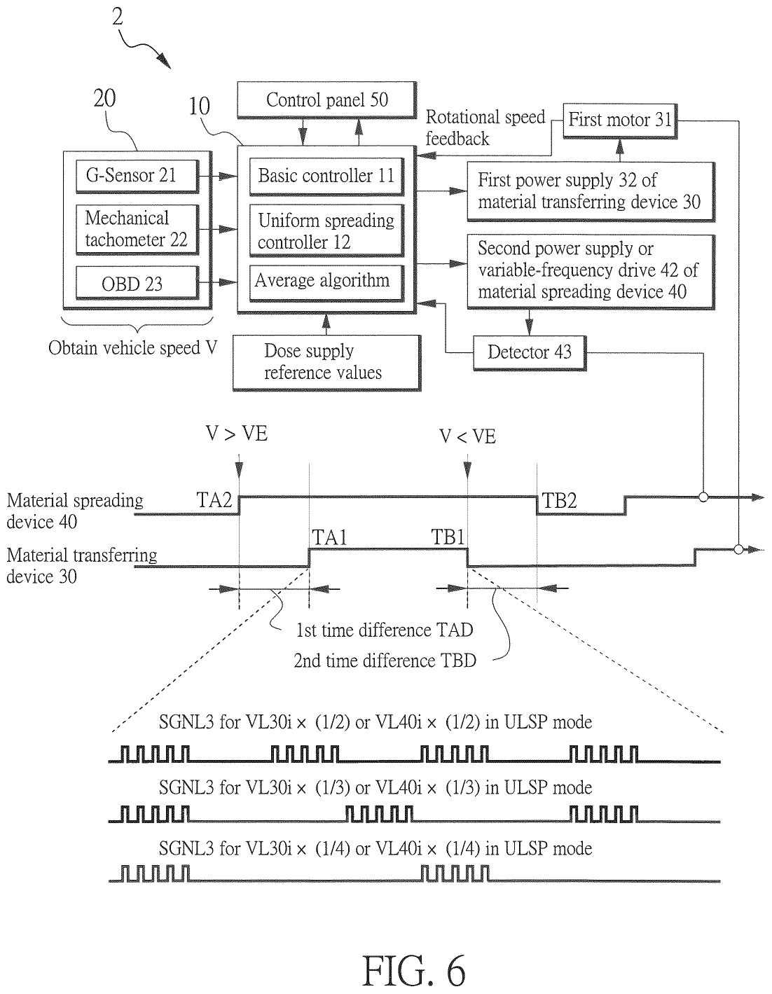

FIG. 6 shows a block diagram of the uniform spreading control system 2 according to another embodiment of the present invention on the top portion of the figure, a timeline illustrating the operation timing for the uniform spreading control system 2 on the middle portion of the figure, and a schematic diagram of three kinds of wave-enveloped pulse trains SGNL3 on the bottom portion of the figure.

The uniform spreading control system 2 can also be equipped in or attached to an aforementioned vehicle to spread an aforementioned material. The detail to be discussed hereinafter may be referred to the previously discussed embodiment with respect to the ultra-low speed pulsation mode.

As shown in FIG. 6, the uniform spreading control system 2 includes a control module 10. The control module 10 includes a basic controller 11 and a uniform spreading controller 12. The control module 10 or the uniform spreading controller 12 can perform an average algorithm. The control module 10 is connected to a vehicle speed detector 20, a material transferring device 30, and a material spreading device 40.

To discuss in detail the uniform spreading mechanism in the stop and go mode of the present invention, the uniform spreading controller 12 of the control module 10 is configured to obtain a vehicle speed V from the vehicle speed detector 20, and accordingly control a material transferring speed V30 of the material transferring device 30 and/or a material spreading speed V40 of the material spreading device 40.

As the material to be spread will be transferred from the material tank via the material transferring device 30 to the material spreading device 40, it can be imagined that, when the vehicle stops, there may be some material remaining on the material spreading device 40. While, when the vehicle starts again, the material spreading device 40 may not start to work immediately, because it may need a start-up time, or as previously mentioned, the signal generated based on the vehicle speed during the start-up time may be still too weak to trigger the material spreading device 40. At this time, if the material transferring device 30 immediately starts to transfer the material, the material will be accumulated on the material spreading device 40, causing not only spreading non-uniformity but also troubles on the whole spreading process. Therefore, the uniform spreading controller 12 of the control module 10 controls not only the speeds but also the operation timings of the material transferring device 30 and the material spreading device 40, so as to avoid material accumulation. In particular, according to the present invention, the uniform spreading controller 12 of the control module 10 is configured to set a first stop time TB1 of the material transferring device 30 to be earlier than a second stop time TB2 of the material spreading device 40, as shown in the middle portion of FIG. 6.

Similarly, in order to let the material spreading device 40 to spread the material as clearly as possible, the material transferring device 30 can be set to stop its transferring action before the material spreading device 40 stop its spreading action, so that the material spreading device 40 can have less material remaining thereon. Therefore, according to the present invention, the uniform spreading controller 12 of the control module 10 may further be configured to set a first start time TA1 of the material transferring device 30 to be later than a second start time TA2 of the material spreading device 40, as shown in the middle portion of FIG. 6.

To quantitively describe the operation in the stop and go mode of the present invention, after the first start time TA1 and the second start time TA2 have been set, there exists a first time difference TAD between the first start time TA1 and the second start time TA2. Similarly, after the first stop time TB1 and the second stop time TB2 have been set, there exists a second time difference TBD between the first stop time TB1 and the second stop time TB2. The first time difference TAD and/or the second time difference TBD may be a fixed value, equal to 0.5 seconds, 1 second, 1.5 seconds, for example, but not limited thereto. Alternatively, the first time difference TAD and/or the second time difference TBD may be a variable value, varying between 0.5 seconds and 1.5 seconds, for example, but not limited thereto. The actual values of the first time difference TAD and the second time difference TBD may be set depending on actual situation, in particular based on experiment results to check how long they shall be set to avoid material accumulation. Moreover, the first time difference TAD and the second time difference TBD may have different values rather than having the same value.

Then, during operation, the uniform spreading controller 12 of the control module 10 is configured to, when the vehicle speed V is higher than a start basic vehicle speed VA, start the material spreading device 40 first, and then after the first time difference TAD elapses, start the material transferring device 30. Similarly, the uniform spreading controller 12 is configured to, when the vehicle speed V is lower than a stop basic vehicle speed VB, stop the material transferring device 30 first, and then after the second time difference TBD elapses, stop the material spreading device 40.

In one embodiment, there may be a material spreading device detector 43 equipped on or attached on the material spreading device 40 and used to detect whether there is any residual material remaining on the material spreading device 40. Accordingly, the control module 10 may further be connected to the material spreading device detector 43, and configured to, before the material spreading device 40 is activated, if the material spreading device detector 43 detects that the material spreading device 40 remains any residual material, then activate the material spreading device 40 to remove or spread the residual material. Doing so can avoid material accumulation on the material spreading device 40 and can even prevent the newly coming material colliding with the residual material and the resulted machine malfunction.

As shown in the bottom portion of FIG. 6, the three kinds of wave-enveloped pulse trains SGNL3 are the same as in FIG. 3, it means that, during the time duration between the second start time TA2 and the second stop time TB2 of the material spreading device 40, the wave-enveloped pulse trains SGNL3 may be used to control the material spreading speed V40 of the material spreading device 40. Similarly, although not shown in the figure, during the time duration between the first start time TA1 and the first stop time TB1 of the material transferring device 30, the wave-enveloped pulse trains SGNL3 may also be used to control the material transferring speed V30 of the material transferring device 30. In other words, this is a combination of the embodiment regarding the stop and go mode and the embodiment regarding the ultra-low speed pulsation mode.

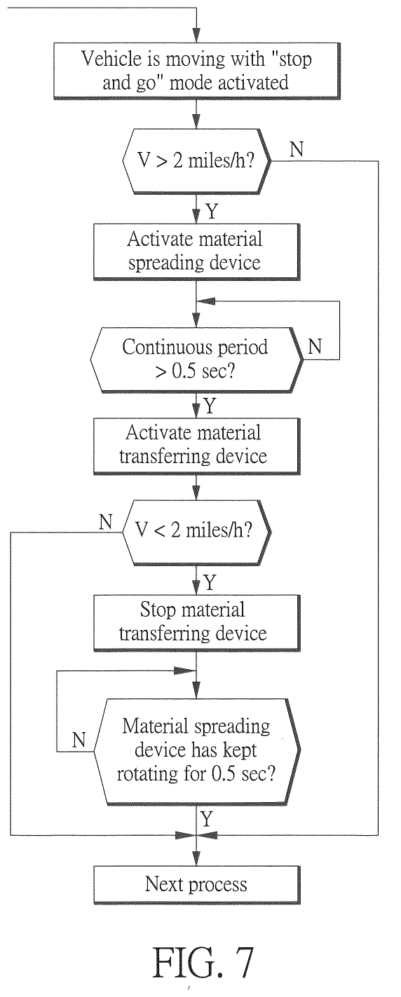

FIG. 7 is a flowchart illustrating the uniform spreading control method, in particular for the stop and go mode, according to another embodiment of the present invention.

Referring to FIG. 7, in the beginning, the vehicle is moving and spreading the material, and we shall remain the stop and go mode activated, rather than in sleep, so that it can cope with the situation whenever the vehicle is detected to frequently stop and go.

It can be understood that, we can say that the vehicle is in normal driving when the vehicle speed V is higher than an effective speed VE, in this case, 2 miles per hour, and continues for an effective time duration, in this case, 0.5 seconds. Otherwise, if the vehicle speed V is too low (lower than an effective speed), or if the vehicle speed V suddenly stops after driving only for a short time (less than 0.5 seconds), we can say that the vehicle is in stop and go driving. The aforementioned effective speed and effective time are set merely for example, but not limited thereto.

Therefore, as shown in FIG. 7, in the first decision box, the uniform spreading control method determines whether the vehicle speed V is higher than the effective speed VE (2 miles per hour, for example); if the answer is yes (Y), it activates the material spreading device 40; if the answer is no (N), it goes to the next process. It can be understood that, the material spreading device 40 shall be activated anyway before the material transferring device 30, so as to remove or spread the residual material in advance.

In the second decision box, the uniform spreading control method keeps checking whether the effective speed continues for an effective time duration, that is, the first time difference TAD (0.5 seconds, for example); if the answer is yes (Y), it activates the material transferring device 30, and the material can be transferred from the material tank via the material transferring device 30 to the material spreading device 40.

The uniform spreading control method has to keep monitoring the vehicle speed V, so in the third decision box, the uniform spreading control method determines whether the vehicle speed V is lower than the effective speed (2 miles per hour, for example); if the answer is no (N), it goes to the next process; if the answer is yes (Y), the material transferring device 30 shall be stopped at first, and then, the material spreading device 40 shall be stopped later after rotating for an end-up duration, that is, the second time difference TBD (0.5 seconds, for example).

The uniform spreading control method in FIG. 7 can be implemented by the uniform spreading control system 2, in particular by the circuit design or program design of the control module 10 or its uniform spreading controller 12. Each process step and each decision in FIG. 7 can be understood following the context of the present description, so the detail thereof is omitted here.

So far, the present specification has illustrated the uniform spreading control system and method in the stop and go mode of the present invention, along with how it solves the technical problem faced by the prior art. The uniform spreading control system and method of the present invention can deal with the situation where the vehicle frequently stops and goes, by introducing time differences for the operation timings of the material transferring device 30 and the material spreading device 40, thereby avoiding material accumulation on the material spreading device 40 itself and spreading non-uniformity on the ground.

Although the present invention has been explained in relation to its preferred embodiment, it is to be understood that, many other possible modifications and variations can be made without departing from the spirit and scope of the invention as hereinafter claimed.

What is claimed is:

1. A uniform spreading control system, comprising:
a control module, which includes a basic controller and a uniform spreading controller, and connected to a vehicle speed detector, a material transferring device, and a material spreading device;
wherein the uniform spreading controller is configured to obtain a vehicle speed from the vehicle speed detector, and control a material transferring speed of the material transferring device and/or a material spreading speed of the material spreading device; and
wherein the uniform spreading controller is configured to enable an ultra-low speed pulsation mode when the vehicle speed is lower than a vehicle speed lower limit.

2. The uniform spreading control system of claim 1, wherein the vehicle speed detector includes an acceleration detector (G-sensor), a mechanical tachometer, and/or an on-board diagnostic (OBD).

3. The uniform spreading control system of claim 1, wherein the control module is further connected to a control panel adapted to be operated by a user.

4. The uniform spreading control system of claim 1, wherein the uniform spreading controller is configured to receive externally or store internally one or more dose supply reference values, perform an average algorithm according to the one or more dose supply reference values, and control the material transferring speed of the material transferring device and/or the material spreading speed of the material spreading device according to a result from the average algorithm.

5. The uniform spreading control system of claim 1, wherein the material transferring device is a belt conveyor, a screw conveyor, or a feeder; and
wherein the material spreading device is a material throwing rotating disc, a material throwing round disc, a spreading rotating disc, or a spreader.

6. The uniform spreading control system of claim 1, wherein the material transferring device includes a first motor and a first power supply, and the uniform spreading controller is configured to control a first power of the first power supply, so as to control a first rotational speed of the first motor, thereby controlling the material transferring speed of the material transferring device; and
wherein the material spreading device includes a second motor and a second power supply or variable-frequency drive, and the uniform spreading controller is configured to control a second power of the second power supply or variable-frequency drive, so as to control a second rotational speed of the second motor, thereby controlling the material spreading speed of the material spreading device.

7. The uniform spreading control system of claim 1, wherein the material transferring speed of the material transferring device and/or the material spreading speed of the material spreading device is fed back to the uniform spreading controller.

8. The uniform spreading control system of claim 1, wherein in the ultra-low speed pulsation mode, the uniform spreading controller is configured to control the material transferring speed of the material transferring device 30 and/or the material spreading speed of the material spreading device by wave-enveloped pulse train.

9. The uniform spreading control system of claim 8, wherein the uniform spreading controller includes a wave-enveloped pulse train generation circuit, the wave-enveloped pulse train generation circuit includes a pulse-width modulation (PWM) timer and a burst timer, the PWM timer is configured to receive pulse train, the burst timer is configured to receive an envelope signal, and the wave-enveloped pulse train generation circuit is configured to perform logic AND operation on the pulse train and the envelope signal, and output the wave-enveloped pulse train.

10. The uniform spreading control system of claim 8, wherein the logic AND operation is implemented by a gating control pin that connects the burst timer to the PWM timer, or implemented by a logic AND gate that is connected to the PWM timer and the burst timer.

11. The uniform spreading control system of claim 8, wherein the vehicle speed lower limit corresponds to an original material transferring speed lower limit (VL30i) of the material transferring device and/or an original material spreading speed lower limit (VL40i) of the material spreading device.

12. The uniform spreading control system of claim 11, wherein the wave-enveloped pulse train is defined with a complete period (T), and the complete period (T) includes a pulse train existing period (Te) and a pulse train non-existing period (Ti); and
wherein a ratio (Te/T) of the pulse train existing period (Te) to the complete period (T) determines a further reduced material transferring speed lower limit (VL30f), equal to the original material transferring speed lower limit [VL30i×(Te/T)] and/or a further reduced material spreading speed lower limit (VL40f), equal to the original material spreading speed lower limit [VL40i×(Te/T)].

13. The uniform spreading control system of claim 1, wherein the vehicle speed lower limit is 10 miles per hour, 8 miles per hour, 6 miles per hour, 4 miles per hour, or 2 miles per hour.

14. The uniform spreading control system of claim 1, wherein the ultra-low speed pulsation mode includes a plurality of sub ultra-low speed pulsation modes, and the sub ultra-low speed pulsation modes include a first sub ultra-low speed pulsation mode and a second sub ultra-low speed pulsation mode;
wherein in the first sub ultra-low speed pulsation mode, the vehicle speed V is between the vehicle speed lower limit and a first vehicle speed lower limit, and the uniform spreading controller is configured to control the material transferring speed of the material transferring device and/or the material spreading speed of the material spreading device by first wave-enveloped pulse train; and
wherein in the second sub ultra-low speed pulsation mode, the vehicle speed is between the first vehicle speed lower limit and a second vehicle speed lower limit, and the uniform spreading controller is configured to control the material transferring speed of the material transferring device and/or the material spreading speed of the material spreading device by second wave-enveloped pulse train.

15. A uniform spreading control system, comprising:
a control module, which includes a basic controller and a uniform spreading controller, and connected to a vehicle speed detector, a material transferring device, and a material spreading device;
wherein the uniform spreading controller is configured to obtain a vehicle speed from the vehicle speed detector, and control a material transferring speed of the material transferring device and/or a material spreading speed of the material spreading device; and
wherein a first start time of the material transferring device is later than a second start time of the material spreading device.

16. The uniform spreading control system of claim 15, wherein a first stop time of the material transferring device is earlier than a second stop time of the material spreading device.

17. The uniform spreading control system of claim 16, wherein there exists a first time difference between the first start time of the material transferring device and the second start time of the material spreading device; and
wherein there exists a second time difference between the first stop time of the material transferring device and the second stop time of the material spreading device.

18. The uniform spreading control system of claim 17, wherein the first time difference and/or the second time difference is a fixed value, equal to 0.5 seconds, 1 second, 1.5 seconds, or a variable value, varying between 0.5 seconds and 1.5 seconds.

19. The uniform spreading control system of claim 17, wherein the uniform spreading controller is configured to, when the vehicle speed is higher than a start basic vehicle speed, start the material spreading device first, and then after the first time difference elapses, start the material transferring device; and
wherein the uniform spreading controller is configured to, when the vehicle speed is lower than a stop basic vehicle speed, stop the material transferring device first, and then after the second time difference elapses, stop the material spreading device.

20. The uniform spreading control system of claim 17, wherein the control module is connected to a material spreading device detector, and the control module is configured to, before the material spreading device is activated, if the material spreading device detector detects that the material spreading device remains any residual material, then activate the material spreading device to remove or spread the residual material.
